(19) United States
(12) Patent Application Publication
(10) Pub. No.: US 2021/0383187 A1
(43) Pub. Date: Dec. 9, 2021

(54) DECENTRALIZED MACHINE LEARNING SYSTEM AND A METHOD TO OPERATE THE SAME

(71) Applicants: Suman Kalyan, Nova Scotia (CA); Angshuman Patra, Mars, PA (US); Subhankar Sahu, Fremont, CA (US); Sujay Kumar, Sunnyvale, CA (US)

(72) Inventors: Suman Kalyan, Nova Scotia (CA); Angshuman Patra, Mars, PA (US); Subhankar Sahu, Fremont, CA (US); Sujay Kumar, Sunnyvale, CA (US)

(21) Appl. No.: 16/893,684

(22) Filed: Jun. 5, 2020

(51) Int. Cl. G06N 3/04; H04L 12/24; G06N 3/08; G06K 9/62; G06N 20/00

(52) U.S. Cl. CPC G06N 3/04; H04L 41/0893; G06N 20/00; G06K 9/6276; G06N 3/08

(57) ABSTRACT

A decentralized machine learning system is disclosed. The system includes one or more learning groups which include one or more learning nodes. The one or more learning groups are formed based on a decision for participation of the one or more learning nodes in decentralized learning via multiple selective node learning flags at a node level. The system also includes a platform server to perform multiple functions. The platform server includes one or more group managers to manage the one or more corresponding learning groups by providing authentication, authorization and harmonization between the one or more learning nodes. The platform server also includes a central connection manager to orchestrate communication among the one or more learning groups for harmonization of the decentralized learning based on a decision for participation of the one or more learning groups via multiple selective group learning flags at a group level.

### BACKGROUND

Embodiments of the present disclosure relate to a platform for processing machine learning techniques and more particularly, to a decentralized machine learning system and a method to operate the same.

Machine learning platforms today follow a command-control model to communicate between different learning nodes. As data privacy becomes paramount, it is evident that the currently available models of machine learning are unable to meet one or more requirements and a need for collaborative learning for development is felt. One such type of the collaborative learning is federated learning which is a machine learning technique which trains a machine learning model across multiple decentralized edge devices or servers holding local data samples, without exchanging their data samples. The federated learning utilizes a general principle which includes training local machine learning models on local data samples and exchanging parameters between such local machine learning models at some frequency to generate a global machine learning model. Generally, the federated learning utilizes a server that coordinates a network of the learning nodes, each of which has local, private training data. The learning nodes contribute to the construction of the global model by training on the local data, and the server combines non-sensitive node model contributions into the global model. Various systems are available which enables the federated learning between one or more learning nodes within a network.

Conventionally, a system available for the federated learning includes utilization of privacy-aware federated learning approaches which makes it possible to train the machine learning model without transferring potentially sensitive user data from the one or more local learning nodes or local deployments to the central server. However, in such a conventional system, the one or more learning nodes while addressing privacy concerns are unable to decide what information it wants to share, with whom and how often. Also, the one or more learning nodes in a large network remain isolated and fail to learn from a subset of the learning nodes within a learning group. In such cases, the one or more learning nodes either stay independent or learn from all the other learning nodes in the network. Moreover, the one or more learning nodes are unable to identify and associate themselves with a similar learning node for collaboration.

Hence, there is a need for an improved decentralized system and a method to operate the same in order to address the aforementioned issues.

### BRIEF DESCRIPTION

In accordance with an embodiment of the present disclosure, a decentralized machine learning system is disclosed. The system includes one or more learning groups which include one or more learning nodes. The one or more learning groups are formed via one or more learning group formation protocols based on a decision for participation of the one or more learning nodes in decentralized learning via multiple selective node learning flags at a node level. The system also includes a platform server operatively coupled to the one or more learning groups. The platform server performs multiple functions for the decentralized learning. The platform server includes one or more group managers corresponding to the one or more learning groups. The one or more group managers are configured to manage the one or more corresponding learning groups by providing authentication, authorization and harmonization between the one or more learning nodes. The platform server also includes a central connection manager operatively coupled to the one or more group managers. The central connection manager orchestrates communication among the one or more learning groups for harmonization of the decentralized learning based on a decision for participation of the one or more learning groups via multiple selective group learning flags at a group level.

In accordance with another embodiment of the present disclosure, a method for operating a decentralized machine learning system is disclosed. The method includes forming, by one or more learning nodes, one or more learning groups via one or more learning group formation protocols based on a decision for participation of the one or more learning nodes in decentralized learning via multiple selective node learning flags at a node level. The method also includes performing, by a platform server, multiple functions for the decentralized learning. The method also includes managing, by one or more group managers, the one or more corresponding learning groups by providing authentication authorization and harmonization between the one or more learning nodes The method also includes orchestrating, by a central connection manager, communication for harmonization of the decentralized learning among the one or more learning groups based on a decision for participation of the one or more learning groups via multiple selective group learning flags at a group level.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a decentralized machine learning system in accordance with an embodiment of the present disclosure;

FIG. 2 illustrates a schematic representation of an exemplary embodiment of a decentralized machine learning system of FIG. 1 in accordance with an embodiment of the present disclosure;

FIG. 3 is a block diagram of a computer or a server in accordance with an embodiment of the present disclosure; and

FIG. 4 is a flow chart representing the steps involved in a method to operate a decentralized machine learning system of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a decentralized machine learning system and a method to operate the same. The system includes one or more learning groups which include one or more learning nodes. The one or more learning groups are formed via one or more learning group formation protocols based on a decision for participation of the one or more learning nodes in decentralized learning via multiple selective node learning flags at a node level. The system also includes a platform server operatively coupled to the one or more learning groups. The platform server performs multiple functions for the decentralized learning. The platform server includes one or more group managers corresponding to the one or more learning groups. The one or more group managers are configured to manage the one or more corresponding learning groups by providing authentication, authorization and harmonization between the one or more learning nodes. The platform server also includes a central connection manager operatively coupled to the one or more group managers. The central connection manager orchestrates communication among the one or more learning groups for harmonization of the decentralized learning based on a decision for participation of the one or more learning groups via multiple selective group learning flags at a group level.

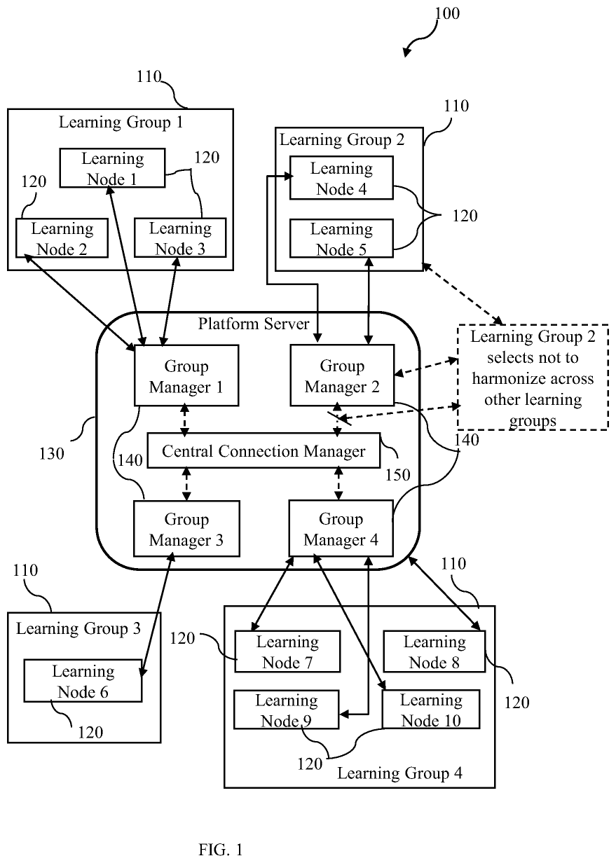

FIG. 1 is a block diagram of a decentralized machine learning system 100 in accordance with an embodiment of the present disclosure. The system 100 includes one or more learning groups 110 which includes one or more learning nodes 120. The one or more learning groups 110 are formed via one or more learning group formation protocols based on a decision for participation of the one or more learning nodes 120 in decentralized learning via multiple selective node learning flags at a node level. As used herein, the term ‘decentralized learning’ is defined as the learning process that enables individual learning or group learning for multiple decentralized nodes or groups within one or more multiple networks. As used herein, the term ‘one or more learning nodes’ are defined as one or more self-contained logical units such as one or more machine learning pipelines in one or more physical nodes of the network. In such embodiment, the one or more learning nodes 120 may store at least one of multiple datatypes used for the one or more machine learning processes, an asset catalog or a combination thereof. In such embodiment, the multiple datatypes may include one or more categories, wherein the one or more categories include relational or structured data category, unstructured or semi-structured text category and media data such as images and videos category.

In one embodiment, the one or more machine learning processes may include, but not limited to, at least one of a deep neural network, a convolutional neural network, a recurrent neural network, a long short-term memory or a combination thereof. In another embodiment, the asset catalog may include a running inventory of multiple local assets in one or more learning nodes 120 including, but not limited to, at least one of multiple machine learning datasets, multiple experiments, multiple historical models, multiple features, multiple machine learning libraries or a combination thereof. The asset catalog is federated to share the catalog items within another of the one or more learning nodes 120 or across the one or more learning groups 110 based on sharing selection made by the one or more learning nodes 120 via the multiple selective node learning flags at the node level.

In one embodiment, multiple selective node learning flags at the node level may include at least one of isolated learning and sharing results protocol, isolated learning and non-sharing results protocol. Each one or more physical nodes may have one or more machine learning processes. Such, one or more machine learning processes may also have multiple selective learning flags. The multiple selective node learning flags at the node level enables the one or more learning nodes 120 to decide on the content of information to be shared with another of the one or more learning nodes and select corresponding one or more learning nodes 120 to share the content of the information with. The isolated learning and sharing results protocol at the node level enables a learning node 120 with multiple machine learning processes to share one or more machine learning model weights created using the one or more machine learning processes but does not receive any updates from a corresponding group manager Again, the isolated learning and the non-sharing results protocol at the node level enables the learning node 120 to neither share any data nor receive updates from a corresponding group manager, this happens when the isolation flag is set to true.

The one or more learning nodes 120 are associated with a machine learning process execution module which executes the one or more machine learning (ML) processes by considering the one or more machine learning processes as a machine learning pipeline. The machine learning pipeline manages multiple processes including, but not limited to, data ingestion, pre-processing, training, and testing processes. The one or more ML processes sends weight matrix of one or more machine models updates to a platform server after ‘n’ number of epochs. After every ‘n’ number of epochs of the one or more ML processes, the ML process looks for weight updates from the platform server in the incoming message queue of the learning node 120 and if the ML process execution module finds an update then swaps out the current intermediate weight matrix with the updated weight matrix and continues training with the same set of hyperparameters are used at the start of the training process. If there is no weight update, then the training continues without any weight update. The one or more ML processes also update a federated asset catalog with the progress of an experiment including the loss function updates after every epoch, the experimental parameters, the resulting model at the end of the process of training.

The one or more learning nodes 120 communicate with the corresponding one or more group managers via a message queue management module. The message queue management module which maintains two queues for communication between the one or more learning nodes and the one or more group managers 140 in the platform server 130. One queue among the two queues is utilized for incoming messages and the other for outgoing messages. In one embodiment, only one queue may handle both incoming and outgoing messages. The incoming messages include data from the platform server 130, wherein the data may include, but not limited to, weight matrix, catalog metadata, one or more control commands and the like. The outgoing queue contains weight matrix messages, the catalog metadata, the one or more control commands and the like to be transmitted to the platform server 130 for computations on the weight matrices from the one or more learning nodes 120. The one or more learning nodes 120 are also associated with the federated asset catalog module which maintains a catalog of metadata for multiple training datasets, multiple test datasets, the multiple experiments, the one or more machine learning models for the one or more learning nodes 120. A master catalog may query the federated asset catalog for a status of the multiple experiments, the multiple features used in the one or more machine learning models being generated in the one or more learning nodes 120, the intermediate values of the loss function and the like. The inference service module provides a predictive response to the one or more learning nodes based on an analysis of feedback collected upon deployment of the one or more machine learning models created using the one or more machine learning processes.

The one or more learning groups 110 are formed via one or more learning group formation protocols based on the decision for the participation of the one or more learning nodes 120 in the decentralized learning. In one embodiment, the one or more learning group formation protocols may include at least one of a message request from the one or more learning nodes for the participation in the decentralized learning, a homogeneous cluster identification technique or a combination thereof. The message request from the one or more learning nodes 120 may be sent manually to one or more learning group owners. Again, the homogeneous cluster identification technique enables identification of the one or more learning nodes 120 for the participation in the decentralized learning based on a calculation of a nearest neighbor metric. The one or more learning nodes 120 with the one or more feature sets of the one or more machine learning processes are compared with another learning node with other feature sets of other one or more machine learning processes. Upon comparison, if the match is more than 75%, then the nearest neighbor techniques are applied to find a matching learning group for the one or more learning nodes 120.

The system 100 also includes the platform server 130 operatively coupled to the one or more learning groups 110. The platform server 130 performs multiple functions for the decentralized learning. The platform server 130 includes one or more group managers 140 corresponding to the one or more learning groups 110. The one or more group managers 140 are configured to manage the one or more corresponding learning groups by providing authentication, authorization and harmonization between the one or more learning nodes 120. The platform server 130 also includes a central connection manager 150 operatively coupled to the one or more group managers 140. The central connection manager 150 orchestrates communication among the one or more learning groups for harmonization of the decentralized learning based on a decision for participation of the one or more learning groups via multiple selective group learning flags at a group level. In a specific embodiment, the central connection manager 150 is only required when a learning group wants to communicate with the one or more other learning groups outside the group. In another embodiment, the central connection manager 150 is not required if learning is within the learning group among the one or more local learning nodes associated with the learning group.

In one embodiment, the multiple selective group learning flags at the group level may include at least one of isolated learning and sharing results protocol at the group level, isolated learning and non-sharing results protocol at the group level, global learning and global sharing protocol at the group level or a combination thereof. The isolated learning and sharing results protocol at the group level enables one learning group 110 to share one or more machine learning model weights created using the one or more machine learning processes of the one or more learning nodes but does not receive any updates from the one or more learning groups via the central connection manager. Similarly, the isolated learning and non-sharing results protocol at the group level enables the one learning group not to share any data outside the learning group but to receive updates from the one or more learning groups 110 via the central connection manager 150. Again, the global learning and global sharing protocol, the selective learning flag is at the group level and enables multiple client organizations to join together for forming a single learning group or multiple learning groups and may learn and share data globally.

The platform server 130 also manages the communication between the central connection manager 150, the one or more learning groups 110 and the one or more learning nodes 120 via a communication management module. The communication mechanism involves weight matrices of the one or more machine learning models that flow from the one or more learning nodes 120 to the one or more corresponding group managers 140 and the weight updates back to the one or more learning nodes 120 after computations on the weight matrices. The communication management component is responsible for collecting all the events across the one or more learning nodes 120, determining the latest events to harmonize across the one or more learning nodes 120 and then sending the latest weight matrix to all the learning nodes. The communication management component includes a server-side module as well as a client-side connector module that helps in determining the latest weight matrix and synchronize the communication with the epoch cycle during the ML Process execution to make the communication efficient.

The platform server 130 also includes a logical component such as a learner harmonization module that harmonizes the decentralized learning across the one or more learning nodes 120 by applying one or more harmonization schemes. In one embodiment, the one or more harmonization schemes may include at least one of weight averaging technique for one or more weight updates of the one or more machine learning processes, swapping of the one or more weight updates of the one or more machine learning processes, one or more weight exchanging techniques between the one or more machine learning processes or a combination thereof.

The platform server 130 also has a component such as a node management module to manage the one or more machine learning processes and administrating one or more physical components such as the one or more learning nodes 120 which participated in the decentralized learning. The node management module is responsible for maintaining a list of the one or more learning nodes 120 involved in the decentralized learning and status of the one or more learning nodes such as offline/inactive/active. Each of the one or more learning nodes 120 needs to register with the one or more corresponding group managers 140 to be able to send model updates in form of the weight matrix and also to receive harmonized models updates back from the corresponding one or more group managers 140 taking into account the multiple selective learning flags which decide, what to apply based on a selected preference of the one or more learning nodes 120. The one or more group managers 140 help in managing and controlling the one or more learning nodes 120 which are distributed for each tenant and provides authentication and authorization from a central location.

The platform manager 130 also includes a logical component such as a message queue management module. The message queue management module maintains two message queues, one for incoming messages and the other for outgoing messages for communicating with the one or more remote learning nodes 120 of the one or more learning groups 110. The incoming messages are messages from the platform server 130 with intermediate weight matrices, catalog metadata, one or more control commands and the like. The outgoing message queue contains a computed weight matrix that is a result of computations on the individual weight matrices from the one or more learning nodes 120, the catalog metadata, the one or more control commands and the like which are transmitted to the platform server 130. The message queue management module also maintains one or more types of queues for establishing a connection between the one or more learning nodes 120 of the one or more learning groups 110 and the platform server 130. Each queue is secured and authorized to be used only when the one or more learning nodes 120 registers to use it. Multiple types of queues are possible and correspond to the selective learning flags selected by the one or more learning groups 110. In one embodiment, the queue is provided where multiple learning groups collaborate to accelerate training. In another embodiment, the queue may also enable a learning group with a single learning node to communicate privately without any collaboration when opted to use isolated selective learning. In yet another embodiment, the queue may be privately shared among a few learning groups by invitation based on the requirement for secured communication. In such case, a learning group does not share the weight matrices to other learning groups.

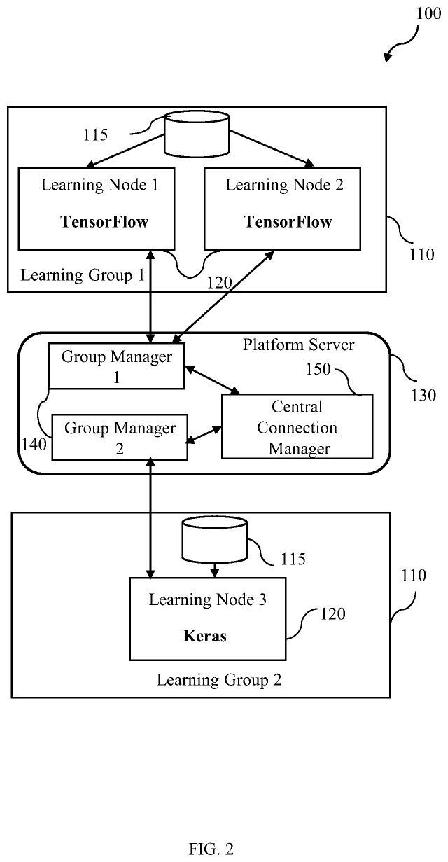

FIG. 2 illustrates a schematic representation of an exemplary embodiment 100 of a decentralized machine learning system of FIG. 1 in accordance with an embodiment of the present disclosure. The system 100 enables orchestration of disparate machine learning processes on the edge such as one or more learning nodes within a localized data network. The system 100 enables individual and group learning for one or more decentralized learning nodes which are connected to a central connection manager that orchestrates the communication across the localized data network. Considering an example, where the system 100 in the localized data network is utilized for executing several machine learning processes for prediction of price of a house in a city. For example, if a median value of the price of the house is ‘X’, the several machine learning processes which are decentralized across the localized data network are executed to predict the price of the house below or above the median value.

For the prediction, the system 100 with multiple components needs to function collaboratively. Let's assume, that the system 100 includes one or more learning groups 110 which include one or more learning nodes 120 to execute one or more machine learning processes. Here, the one or more learning nodes 120 are enabled to decide for participation in decentralized learning within the localized data network via multiple selective node learning flags at a node level. For example, the multiple selective node learning flags includes at least one of isolated learning and sharing results protocol at the node level, isolated learning and non-sharing results protocol at the node level or a combination thereof. So, the one or more learning nodes 120 if wants to participate in the collaborative learning, then it may select the group learning and results sharing protocol for sharing model weights of one or more machine learning models created using the one or more machine learning processes and also receives weight matrix updates from a centralized location. The one or more learning nodes 120 are computing devices of predefined storage and computation configuration.

The one or more learning nodes 120 which executes the one or more machine learning processes for the prediction of the price of the house, store at least one of multiple datatypes, an asset catalog or a combination thereof. For example, the multiple datatypes may include relational or structured data. Again, the asset catalog may include a running inventory of multiple local assets in the one or more learning nodes 120 including, but not limited to, at least one of multiple machine learning datasets, multiple experiments, multiple historical models, multiple features, multiple machine learning libraries or a combination thereof. The asset catalog is federated to share the catalog items within another of the one or more learning nodes 120 or across multiple groups based on sharing selection made by the one or more learning nodes 120 via the multiple of selective node learning flags. Also, the one or more learning groups 110 are enabled to share the data at the group level with other learning groups by selecting multiple selective group learning flags.

The one or more learning groups 110 are formed by via one or more learning group formation protocols based on the decision for the participation of the one or more learning nodes 120 in the decentralized learning. For example, the one or more learning group formation protocols may include at least one of a message request from the one or more learning nodes 120 for the participation in the decentralized learning. So, here, the one or more learning nodes 120 which are executing the one or more machine learning processes may manually send the message request to a learning group owner for joining with the at least one learning group executing similar types of tasks. Let's assume that, a learning node 1 120 and a learning node 2 120 of a learning group 1 is predicting the price of the house by a neural network using a TensorFlow® library. Again, a learning node 3 120 of a learning group 110 is also trying to predict the price by using another neural network and using a Keras® library. The libraries are stored in a running inventory of asset catalog 115. Similarly, there are also multiple other learning nodes of other corresponding learning groups which are executing the prediction problem using the machine learning technique. So, learning nodes of different learning groups may federate or collaborate based on requirement.

For federation among the one or more learning groups 110, the one or more learning nodes 120 needs to be connected with the centralized location which harmonizes the decentralized learning. At the centralized location, a platform server 130 is present, which further includes one or more group managers 140 corresponding to the one or more learning groups 110 and a central connection manager 150. The one or more group managers 140 manages the one or more corresponding learning groups by providing authentication authorization and harmonization between the one or more learning nodes 120. The central connection manager 150 orchestrates the communication among the one or more learning groups 110 for harmonization of the decentralized learning based on a decision for participation of the one or more learning groups 110 via the multiple selective group learning flags at the group level. The one or more group managers 140, and the central connection manager 150 together with the multiple selective learning flags provide a basis for managing all the learning processes in the localized data network.

So, that when the learning node 1 needs to collaborate with the learning node 3, then weight matrices of the learning node 1 of the learning group 1 after ‘n’ number of epochs is communicated to the corresponding group manager 1 via message queues. The group manager 1 updates the weight matrices back to the learning node 1 after computations on the weight matrices received from other learning nodes. The communication endpoints used herein, are message queues for the group manager 1 and message queues for the learning node 1. The group manager 1 does not wait for all the weight matrices from the one or more learning nodes 120 to perform computations. It does computations when more than 1 weight matrix is available in the incoming message queue on the platform server 130. As, a result, the group manager 1 in the example used herein, harmonizes the decentralized learning among several learning nodes. The harmonization is obtained by applying one or more harmonization schemes which may include, but not limited to, at least one of weight averaging technique for one or more weight matrix updates of the one or more machine learning processes, swapping of the one or more weight matrix updates of the one or more machine learning processes, one or more weight exchanging techniques between the one or more machine learning processes or a combination thereof. Upon harmonization, when the final prediction for the price of the house is completed and if the learning is determined as complete, then, the machine learning model which was trained for prediction of the price of the house by the learning node 1, is prepared for deployment. The machine learning model is deployed at a registered learning node 1 and may also provide a predictive response. Also, one or more learning parameters, multiple assets from the asset catalog are either stored only locally or shared with other learning nodes of the one or more learning groups 110, so that every learning node is able to potentially learn more than what was possible through learning in an offline mode.

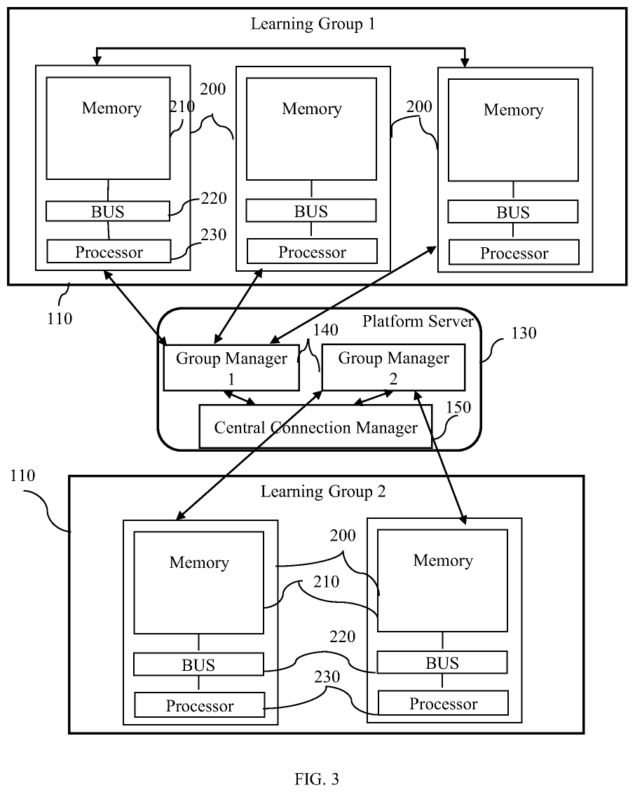

FIG. 3 is a block diagram of a computer or a server in accordance with an embodiment of the present disclosure. The computer 200 includes processor(s) 230, and memory 210 operatively coupled to the bus 220. The computer 200 is substantially similar to one or more learning nodes 120 of a decentralized machine learning system of FIG. 1. The learning node 120 includes the processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes multiple modules stored in the form of executable program which instructs the processor 230 to perform the method steps illustrated in FIG. 1. The memory 210 has following modules: a machine learning process execution module, a federated asset catalog module and an inference module. The machine learning process execution module executes the one or more machine learning (ML) processes by considering the one or more machine learning processes as a machine learning pipeline. The machine learning pipeline manages data ingestion, pre-processing, training, and testing processes. The one or more ML processes sends weight matrix of one or more machine models updates to a platform server after ‘n’ number of epochs and receiving the weight matrix updates from the platform server. The message queue management module maintains two message queues such as one queue among the two queues for incoming messages and the other queue for outgoing messages. The incoming messages are the weight matrix, catalog metadata, one or more control commands and the like updates from the platform server. The outgoing queue contains weight matrix messages to be transmitted to the platform server for computations on the weight matrices from the one or more learning nodes. The federated asset catalog module maintains a catalog of metadata for multiple training datasets, multiple test datasets, the multiple experiments, the one or more machine learning models for the one or more learning nodes. A master catalog may query the federated asset catalog for status of the multiple experiments, the multiple features used in the one or more machine learning models being generated in the one or more learning nodes 120, the intermediate values of the loss function and the like. The inference module to provide a predictive response to the one or more learning nodes based on an analysis of feedback collected upon deployment of the one or more machine learning models created using the one or more machine learning processes.

The bus 220 as used herein refers to internal memory channels or computer network that is used to connect computer components and transfer data between them. The bus 220 includes a serial bus or a parallel bus, wherein the serial bus transmits data in a bit-serial format and the parallel bus transmits data across multiple wires. The bus 220 as used herein, may include but not limited to, a system bus, an internal bus, an external bus, an expansion bus, a frontside bus, a backside bus and the like.

The one or more learning nodes 120 of one or more learning groups 110 in the decentralized environment is operatively coupled to a platform server 130. The platform server 130 includes the one or more group managers 140 corresponding to the one or more learning groups 110 wherein the one or more group managers 140 manage the one or more corresponding learning groups 110 by providing authentication authorization and harmonization between the one or more learning nodes. The platform server also includes a central connection manager 150 which orchestrates communication among the one or more learning groups for harmonization of the decentralized learning based on a decision for participation of the one or more learning groups via multiple selective group learning flags at a group level.

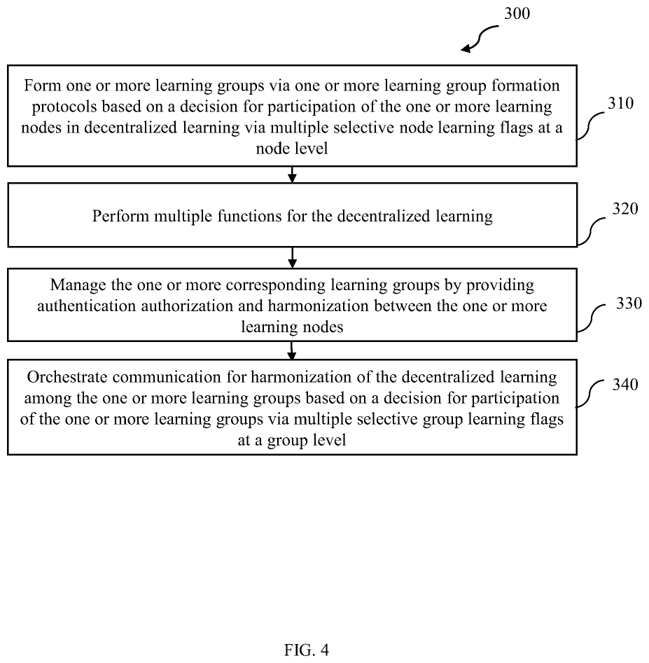

FIG. 4 is a flow chart representing the steps involved in a method 300 of operation of a decentralized machine learning system of FIG. 1 in accordance with the embodiment of the present disclosure. The method 300 includes forming, by one or more learning nodes, one or more learning groups via one or more learning group formation protocols based on a decision for participation of the one or more learning nodes in decentralized learning via multiple selective node learning flags at a node level in step 310. In one embodiment, forming the one or more learning groups may include forming the one or more learning groups by including the one or more learning nodes for executing the one or more machine learning processes which may include, but not limited to, a deep neural network, a convolutional neural network, a recurrent neural network, a long short-term memory and the like. In one embodiment, executing the one or more machine learning processes by the one or more learning nodes may include executing the one or more machine learning processes by one or more computing devices of predefined storage and computation configurations. In such embodiment, the one or more learning nodes may store at least one of multiple datatypes used for the one or more machine learning processes, an asset catalog or a combination thereof.

In one embodiment, storing the asset catalog may include storing a running inventory of multiple local assets in the one or more learning nodes which may include, but not limited to, at least one of multiple machine learning datasets, multiple experiments, multiple historical models, multiple features, multiple machine learning libraries or a combination thereof. In a specific embodiment, executing the one or more machine learning processes wherein the one or more learning nodes are enabled to decide for participation in the decentralized learning within the localized data network via the multiple selective node learning flags at the node level, which may include executing the one or more machine learning processes by the one or more learning nodes based on the decision of the participation in the decentralized learning based on at least one of isolated learning and sharing results protocol, isolated learning and non-sharing results protocol or a combination thereof.

In one embodiment, forming the one or more learning groups by the one or more learning nodes may include forming the one or more learning groups via the one or more learning group formation protocols which may include at least one of a message request from the one or more learning nodes for the participation in the decentralized learning, a homogeneous cluster identification technique or a combination thereof. In such embodiment, the message request may include the message request from the one or more learning nodes which may be sent manually to an owner of the one or more learning groups. In another embodiment, the homogeneous cluster identification technique enables automatic identification of the one or more learning nodes for the participation in the decentralized learning based on a calculation of a nearest neighbor metric.

The method 300 also includes performing, by a platform server, multiple functions for the decentralized learning in step 320. In one embodiment, performing the multiple functions for the decentralized learning may include performing the multiple functions such as at least one of management of one or more owners of the one or more learning nodes, management of connectivity across the one or more learning nodes, orchestration of communication across the one or more learning nodes, propagation of learning within and across the at least one learning group or a combination thereof. In such embodiment, the multiple functions of the platform server for the decentralized learning may be managed by a communication management module, a learner harmonization module, a node management module and a message queue management module.

The method 300 also includes managing, by one or more group managers, the one or more corresponding learning groups by providing authentication authorization and harmonization between the one or more learning nodes in step 330. The method 300 also includes orchestrating, by a central connection manager, communication for harmonization of the decentralized learning among the one or more learning groups based on a decision for participation of the one or more learning groups via multiple selective group learning flags at a group level in step 340.

Various embodiments of the present disclosure relate to a platform which enables individual as well as group learning for one or more decentralized learning nodes in a network that are connected to the central connection manager through the group manager which orchestrates the communication across the network in a secured and a hassle free-manner based on the distribution of workloads. Also, such a platform helps in avoiding a centralized failure.

Moreover, the present disclosed system provides an option of selective learning to the one or more learning nodes, so that the one or more learning nodes may able to decide what information to share with other learning nodes, with whom the information should be shared and when the information needs to be shared for the federated learning.

Furthermore, the present disclosed system forms a learning group by automatic identification of homogeneous clusters within the network so that there is harmonization in the decentralized learning.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A decentralized machine learning system comprising:
one or more learning groups comprising one or more learning nodes, wherein the one or more learning groups are formed via one or more learning group formation protocols based on a decision for participation of the one or more learning nodes in decentralized learning via a plurality of selective node learning flags at a node level; and
a platform server operatively coupled to the one or more learning groups, wherein the platform server is configured to perform a plurality of functions for the decentralized learning, wherein the platform server comprises:
one or more group managers corresponding to the one or more learning groups, wherein the one or more group managers are configured to manage the one or more corresponding learning groups by providing authentication, authorization and harmonization between the one or more learning nodes; and
a central connection manager operatively coupled to the one or more group managers, wherein the central connection manager is configured to orchestrate communication among the one or more learning groups for harmonization of the decentralized learning based on a decision for participation of the one or more learning groups via a plurality of selective group learning flags at a group level.

2. The system of claim 1, wherein the one or more learning nodes comprises one or more self-contained logical units in one or more physical nodes of one or more networks.

3. The system of claim 1, wherein the one or more learning nodes store at least one of a plurality of datatypes used for the one or more machine learning processes, an asset catalog or a combination thereof.

4. The system of claim 3, wherein the asset catalog comprises at least one of a plurality of machine learning datasets, a plurality of experiments, a plurality of historical models, a plurality of features, a plurality of machine learning libraries or a combination thereof.

5. The system of claim 1, wherein the one or more learning nodes are associated with a machine learning process execution module, message queue management module, a federated asset catalog module and an inference service module for handling one or more activities.

6. The system of claim 5, wherein the inference service module is configured to provide a predictive response to the one or more learning nodes based on an analysis of feedback collected upon deployment of one or more machine learning models created using the one or more machine learning processes.

7. The system of claim 1, wherein the one or more learning nodes execute one or more machine learning processes comprising at least one of a deep neural network, a convolutional neural network, a recurrent neural network, a long short-term memory or a combination thereof.

8. The system of claim 1, wherein the plurality of selective node learning flags at the node level comprises at least one of isolated learning and sharing results protocol, isolated learning and non-sharing results protocol or a combination thereof.

9. The system of claim 1, wherein the plurality of selective group learning flags at the group level comprises at least one of isolated learning and sharing results protocol at the group level, isolated learning and non-sharing results protocol at the group level, global learning and global sharing protocol, global learning and non-sharing protocol or a combination thereof.

10. The system of claim 1, wherein the plurality of selective node learning flags is configured to enable the one or more learning nodes to decide on a content of information to be shared with another of the one or more learning nodes and select corresponding one or more learning nodes or the one or more learning groups to share the content of the information with.

11. The system of claim 1, wherein the one or more learning group formation protocols comprises at least one of a message request from the one or more learning nodes for the participation in the decentralized learning, a homogeneous cluster identification technique or a combination thereof.

12. The system of claim 11, wherein the homogeneous cluster identification technique enables identification of one or more learning nodes for the participation in the decentralized learning based on a calculation of a nearest neighbor metric.

13. The system of claim 1, wherein the plurality of functions of the platform server comprises at least one of management of one or more owners of the one or more learning nodes, management of connectivity across the one or more learning nodes, orchestration of communication across the one or more learning nodes, propagation of learning within and across the one or more learning groups or a combination thereof.

14. The system of claim 1, wherein the central connection manager is inessential for orchestration of the communication across one or more networks when the decentralized learning is within a learning group among the one or more learning nodes.

15. The system of claim 1, wherein the platform server comprises a communication management module, a learning harmonizer module, a message queue management module and a node management module.

16. The system of claim 15, wherein the learning harmonizer module is configured to harmonize the decentralized learning across the one or more learning nodes within one or more networks by applying one or more harmonization schemes.

17. The system of claim 16, wherein the one or more harmonization schemes comprises at least one of weight averaging technique for one or more weight updates of the one or more machine learning processes, swapping of weight updates of the one or more machine learning processes, weight exchanging techniques between the one or more machine learning processes or a combination thereof.

18. The system of claim 15, wherein the message queue management module is configured to maintain one or more types of queues for establishing a connection between the one or more learning nodes of the one or more learning groups and the platform server.

19. A method comprising:
forming, by one or more learning nodes, one or more learning groups via one or more learning group formation protocols based on a decision for participation of the one or more learning nodes in decentralized learning via a plurality of selective node learning flags at a node level;
performing, by a platform server, a plurality of functions for the decentralized learning;
managing, by one or more group managers, the one or more corresponding learning groups by providing authentication authorization and harmonization between the one or more learning nodes; and
orchestrating, by a central connection manager, communication for harmonization of the decentralized learning among the one or more learning groups based on a decision for participation of the one or more learning groups via a plurality of selective group learning flags at a group level.
